(19) United States
(12) Patent Application Publication
(10) Pub. No.: US 2005/0163684 A1
(43) Pub. Date: Jul. 28, 2005

(54) Self-propelled pool chemical dispenser

(76) Inventor: Otis P. Sherr, Encinitas, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 10/758,467

(22) Filed: Jan. 14, 2004

(51) Int. Cl. C02F 1/50

(52) U.S. Cl. 422/265

(57) ABSTRACT

The present invention is directed to a self propelled chemical dispensing apparatus. It describes an invention that will take the shape of a fish but will also be in a variety of different shapes and configurations. The device has been conceived to disperse chemicals for the purpose of sanitation or purification of water in swimming pools and spas as well as in ponds and waterways. A unique feature of this device allows it to propel itself through the water by moving a tail back and forth or by a propeller powered by an electric motor and battery. The battery in some cases may be recharged by the means of photovoltaic power cells on the exterior surface. As it propels itself through the water, water is taken in the front through a water intake orifice. The water passing through the internal cavity of the head or frontal element will dissolve the water-soluble chemicals and disperse them through the water exit orifices. The amount of dissolved chemicals can be controlled by one or more sliding doors within the internal cavity of the head or frontal element.

### FIELD OF THE INVENTION

This invention relates to the field of pools, which require the dispersement of chemicals for the purpose of sanitation or purification. More specifically this patent deals with the even distribution and controlled dispersement of chemicals in pools, ponds and waterways. The most common usage of this invention will be in the field of dispersing chemicals evenly throughout a swimming pool with an ornamental self-propelled device.

In many areas, this unique device could rectify the ever-growing problem of mosquitoes and contamination in stagnant ponds and waterways.

### BACKGROUND OF THE INVENTION

This invention describes a new and unique self-propelled pool chemical dispenser that will maneuver itself through the water while evenly dispersing a given amount of chemicals into a pool, pond or waterway. Chemicals for swimming pools are in a variety of forms. For instance, chlorine, which is commonly used in swimming pools, is available in granules, large and small tablets and in concentrated liquid form. Conventionally each of these forms is differently packaged. Some of the chemicals are hand-scattered or introduced by elaborate automatic mechanical apparatus or by complicated floating release mechanisms. Many of the chlorine and other pool chemical distribution systems are unsightly when exposed in the pool area. The chemical distributors thereby detract from the decor of the pool in addition to being difficult to maintain because of their complicated operation. Additionally, these chemical distribution systems have been designed specifically for the use in swimming pools only and are not self-propelled or would not be usable in other environments like ponds or waterways.

The self-propelled pool chemical dispensing invention is therefore directed to distribute chemicals in a variety of configurations that will harmonize with the decor of the swimming pool and also acts to distribute the chemicals evenly throughout the pool water, thereby eliminating many of the difficulties set forth in the following patents.

U.S. Pat. No. 3,607,103 of Adolph Klefer describes a buoyant container for dispensing a solid chemical composition while floating on the surface of a liquid that has a compartment for confining the chemical composition arranged with respect to the center of buoyancy so that the attitude of the container when empty is substantially different than the attitude of the container when the compartment is filled.

This patent describes a floating chemical dispenser but does not have the capability of moving itself through the water or the ability of being used in other environments.

U.S. Pat. No. 3,677,711 of Willian T. Bond discloses a float ring that contains cavities each filled with a soluble pool chemical such as chlorine tablets or granules. A tube cap protrudes an adjustable amount from each cavity of the float ring and an aperture of each tube is in the protruded portion. Each tube cap is adjustable in its float ring cavity to change the area of the tube cap aperture effectively open to pool water so as to alter the rate at which the chemical dissolves into the pool.

This patent describes another floating chemical dispenser but does not have the capability of moving itself through the water or the ability of being used in other environments.

U.S. Pat. No. 4,630,634 of Isao Sasaki teaches of a chlorine dispenser for spas that includes a tubular container disposed within a sleeve having one closed end. The container and sleeve form a chamber for receiving the solid chlorine source. The sleeve contains apertures for providing access by water to the solid chlorine source. The sleeve is axially movable along the container, and a locknut engages the container to secure a given position of the sleeve. The container is attached to a foam-filled float, which ensures positive buoyancy of the dispenser in water. The sleeve is ballasted to ensure that the dispenser is vertically disposed in the water.

Again this patent describes another floating chemical dispenser but does not have the capability of moving itself through the water or the ability of being used in other environments.

U.S. Pat. No. 4,217,331 of Charles T. Schuab additionally describes a float dispenser that is adapted to be floated in a body of water such as a swimming pool, to dispense in the water a soluble solid material carried by the dispenser. The dispenser includes a flotation element from which an apertured receptacle is supported below the water. The receptacle is divided into separate compartments. A single tablet of water soluble material is located within each compartment so that the tablet is segregated from the other tablets to expose to maximum surface areas to the surrounding water. The dispenser may be made of two identical integral half sections of molded plastic material, which are locked together to lock the tablets within their individual compartments. After dissolution of the tablets, the dispenser may be discarded and replaced with another.

This patent describes still another floating chemical dispenser. The floating chemical dispensers have a tendency to float to the same location and not to circulate around the complete pool surface

None of the foregoing prior art teaches or suggests the particular unique features of the self-propelled pool chemical dispenser and thus clarifies the need for further improvements in the devices that can distribute chemicals in pools, ponds and waterways.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### SUMMARY OF THE INVENTION

The principal object of the self-propelled pool chemical dispenser is to create a means to evenly distribute and control the dispersement of chemicals in pools, ponds and waterways.

Another object is to create an ornamental pool chemical dispenser that is self-propelled and will maneuver itself through the water.

Another object is to create a self-propelled pool chemical dispenser that will carry a photovoltaic energy cell to generate electricity to maintain a charge in the battery.

Another object is to create a self-propelled pool chemical dispenser that can function in a variety of unique configurations.

Another object is to create a self-propelled pool chemical dispenser that will have a cavity that will hold a variety of sizes and kinds of chemicals for dispersement.

Another object is to create a self-propelled pool chemical dispenser that will have one or more adjustable fins that will control the direction or size of the circle that the device will travel within.

And still another object is to create a self-propelled pool chemical dispenser that will have an adjustment to control the amount of chemicals dispensed into the water.

Yet another object is to create a self-propelled pool chemical dispenser that can navigate freely or be tethered on a line to an anchor and rotate within a confined circular area.

A further object is to create self-propelled pool chemical dispensers that can dispense chemicals in stagnant pools, ponds or waterways to decontaminate the water or rid the area of mosquitoes.

A final object of this invention is to add a new and unique device to the area of pool supplies and chemical dispensers.

The preferred embodiment of this invention will take the shape of a fish but it must be understood that it may be created in a variety of different shapes and still fall within the scope of this patent. This device has been designed to disperse chemicals for the purpose of sanitation or purification of water in swimming poor and spas as well as in ponds and waterways. One of the unique features of this device allows it to propel itself through the water with an electric motor powered by a battery that in some cases may be recharged by photovoltaic power cells on the exterior surface. The action of propelling the device through the water by the means of moving a tail back and forth will minimize the device being tangled by weeds or other articles in the water when used in ponds and waterways.

As it propels itself through the water, water is taken in the front through a water intake orifice that in some cases will be in the configuration of the mouth of a fish and exit through water exit orifices that in some cases will be in the configuration of the gills of a fish. The water passing through the internal cavity of the head or frontal element will dissolve the water-soluble chemicals and disperse them through the water exit orifices. The amount of dissolved chemicals can be controlled by one or more sliding doors within the internal cavity of the head or frontal element. The stability of the device is maintained by the means of a flotation unit at the top of the body and ballast at the bottom. Direction of the device can be either maintained or altered by the means of dorsal and pectoral fins at the top and bottom of the device. As it floats higher in the water it displays more of the dorsal fin when the chemicals have been depleted.

The device is compact, aesthetically attractive, long lasting, easily filled with chemicals and precisely adjustable, and is effective and efficient. The self-propelled pool chemical dispenser can be used with soluble source materials of diverse manufacture, thus giving the user freedom to select the source material he deems best for his needs. The self-propelled pool chemical dispenser is especially useful with source chemicals provided in tablet or stick form.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention. There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 depicts a side elevation of the preferred embodiment of the self-propelled pool chemical dispenser, shown as a conventional freshwater fish, sectioned through the body area with the head or frontal element exploded away;

FIG. 2 depicts an end view of the central body area of the self-propelled pool chemical dispenser;

FIG. 3 depicts a section through the head portion of the self-propelled pool chemical dispenser;

FIG. 4 depicts a perspective view of the prior art, namely a passive pool chemical dispenser;

FIG. 5 depicts the self-propelled pool chemical dispenser configured as a submarine;

FIG. 6 depicts the self-propelled pool chemical dispenser configured as a shark;

FIG. 7 depicts the self-propelled pool chemical dispenser configured as a larger fish;

FIG. 8 depicts the self-propelled pool chemical dispenser configured as an Orca whale; and

FIG. 9 depicts the self-propelled pool chemical dispenser configured is a basic cylindrical shape to be tethered to a weight on the bottom to go in a confined circular pattern.

### DETAILED DESCRIPTION OF THE PREFERRED EMBODIMENTS

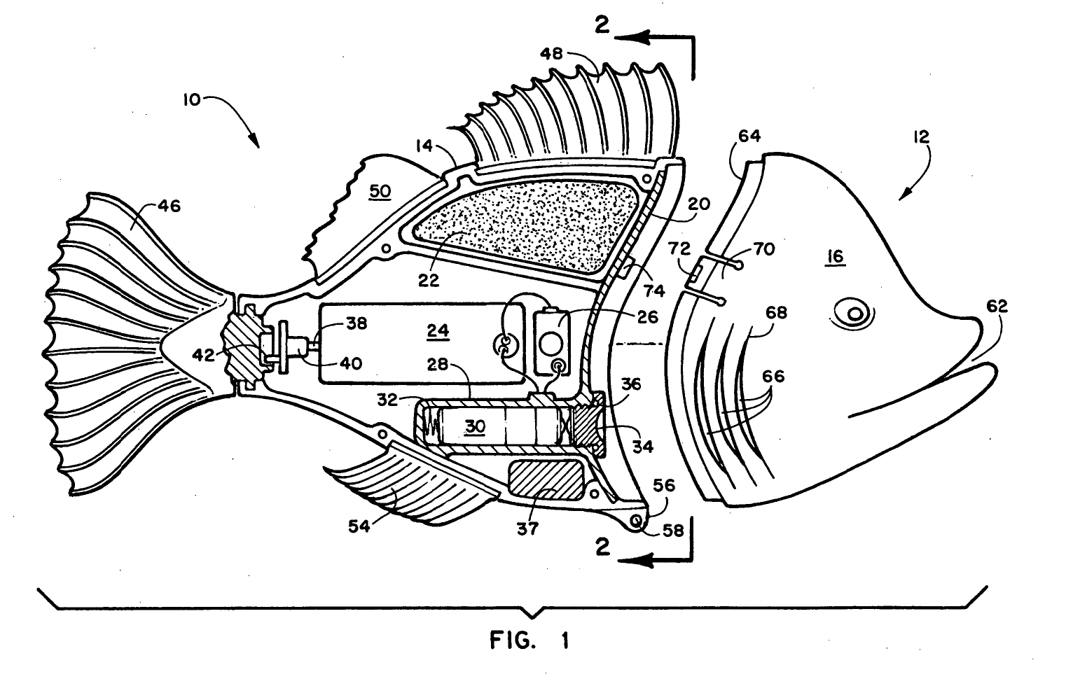

Referring now to the drawings, wherein similar parts of the self-propelled pool chemical dispenser 10 are identified by like reference numerals, there is seen in FIG. 1 a side elevation of the preferred embodiment of the self-propelled pool chemical dispenser 10 shown as a conventional freshwater fish 12. The device has been sectioned through the body 14 with the head or frontal element 16 exploded away, where the chemicals to dispense are stored. The body 14 has been shown with the left side 18 removed and the front wall 20 shown in section to display the flotation unit 22, the sealed electric motor 24 with wires going to the on/off switch 26 and the sealed battery compartment 28. The battery 30 is held in place between a spring 32 and a threaded cap 34. The battery compartment 28 is sealed by the means of an o-ring 36 under the threaded cap 34. Below the sealed battery compartment 28 is a ballast unit 37 to work in combination with the flotation unit 22 to maintain the desired attitude of the device. The sealed electric motor 24 rotates a shaft 38 turning a rotational actuator 40 with an actuator pin 42 that translates within a slot 44 to make the tail 46 of the self-propelled pool chemical dispenser 10 move back and forth in a natural swimming motion of the freshwater fish 12. The primary dorsal fin 48 is located on the upper back of the body 14 and can be used to determine the level of chemicals left in the device by how far it rises above the surface of the water. A secondary dorsal fin 50 will be located further back on the body 14 and may be permanently positioned to direct the device in a specific circular pattern or may be flexible to be bent into the desired position to direct the movement of the device. At the bottom 52 of the device will be a pectoral fin 54 that may also be permanently positioned to direct the device in a specific circular pattern or may be flexible to be bent into the desired position to direct the device through the water. A tether attachment 56 is located on the bottom 52 of the body 14 of the device with an orifice 58 in which to tie a tether line 60.

The head or frontal element 16 will have one or more water entry orifices 62 configured to look like the mouth of the freshwater fish 12 to allow water to enter the internal cavity 64 and pass by the chemicals and through the water exit orifices 66 configured to look like gills 68 of the freshwater fish 12. A conventional locking device will have one or more flexible tabs 70 with a nib 72 that will releaseably lock within a cavity 74 in the body 14 of the freshwater fish 12.

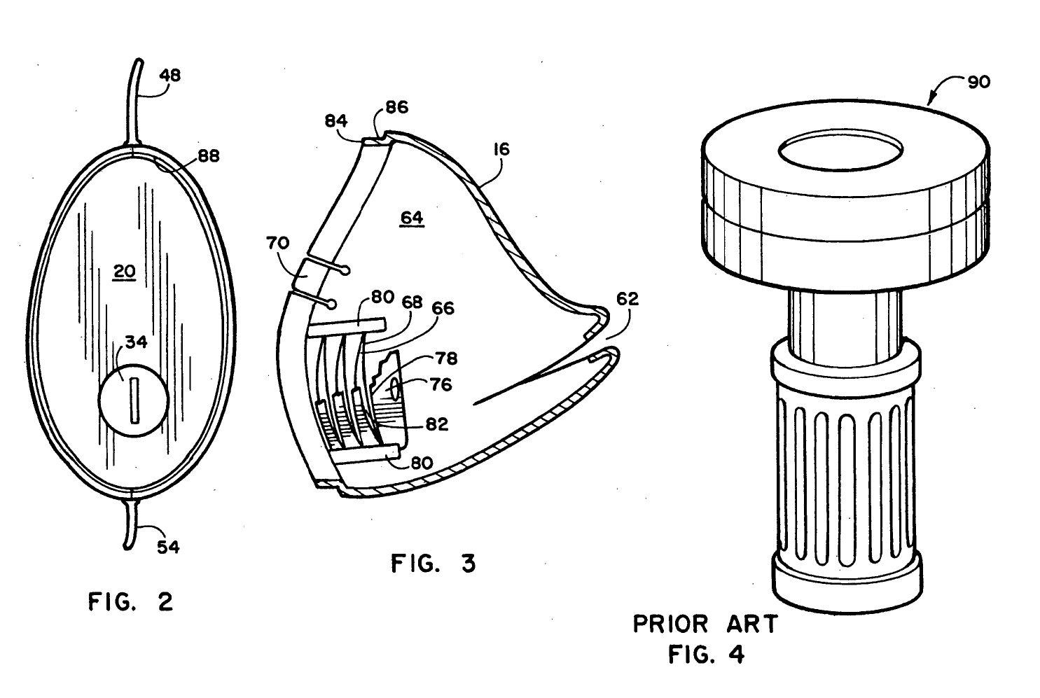

FIG. 2 depicts an end view of the central body 14 of the self-propelled pool chemical dispenser 10 in the shape of a freshwater fish 12. This view shows the front wall 20 with the threaded cap 34 in place.

FIG. 3 depicts a section through the head or frontal element 16 of the self-propelled pool chemical dispenser 10 defining the internal cavity 64 where the chemicals are placed. The exit orifice 66 configured to look like gills 68 have a sliding door 76 with orifices 78 to match the exit orifices 66 so that when the sliding door 76 is adjusted within the tracks 80 the size of the controlled exit orifice opening 82 is reduced. The perimeter 84 of the head or frontal element 16 has a stepped section 86 to fit within the outer perimeter 88 of the body 14.

FIG. 4 depicts a perspective view of the prior art of a pool chemical dispenser 90 that floats vertically in the pool and is primarily affected by the pool currents and the wind over the surface. These devices are generally effective in small pools and spas.

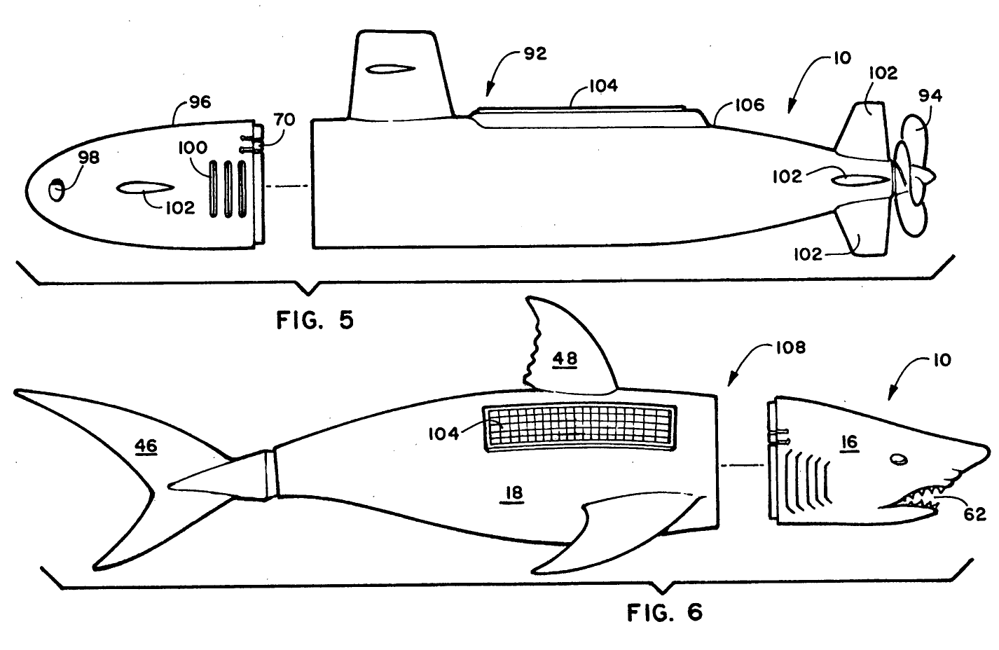

FIG. 5 depicts the self-propelled pool chemical dispenser 10 configured as a submarine 92 driven by a conventional propeller 94 in the conventional manner with the frontal element 96 exploded away. The frontal element 96 will have one or more entry orifices 98 for the water to enter and a plurality of water exit louvers 100. The submarine 92 will require both front and back stabilizing fins 102 to aide in stabilizing and steering the device and is shown with a photovoltaic energy cell 104 on the top side 106.

FIG. 6 depicts the self-propelled pool chemical dispenser configured as a shark 108 with photovoltaic energy cells 104 on the sides.

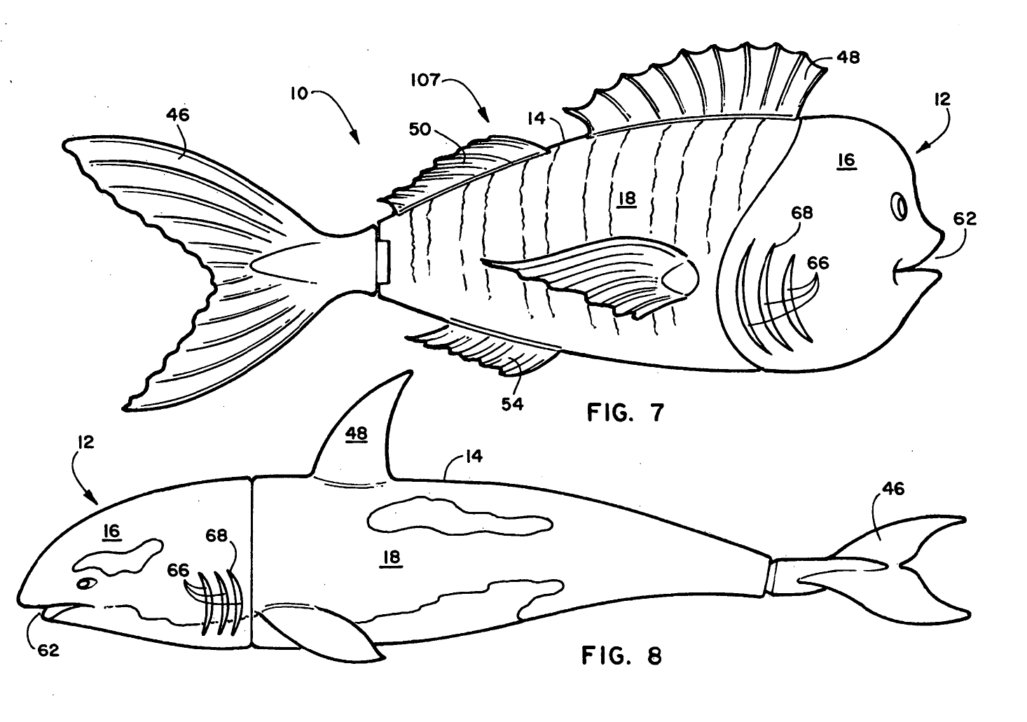

FIG. 7 depicts the self-propelled pool chemical dispenser 10 configured as a larger saltwater fish 107 with an enlarged head or frontal element 16 to carry a larger amount of chemicals.

FIG. 8 depicts the self-propelled pool chemical dispenser 10 configured as an Orca or killer whale 108.

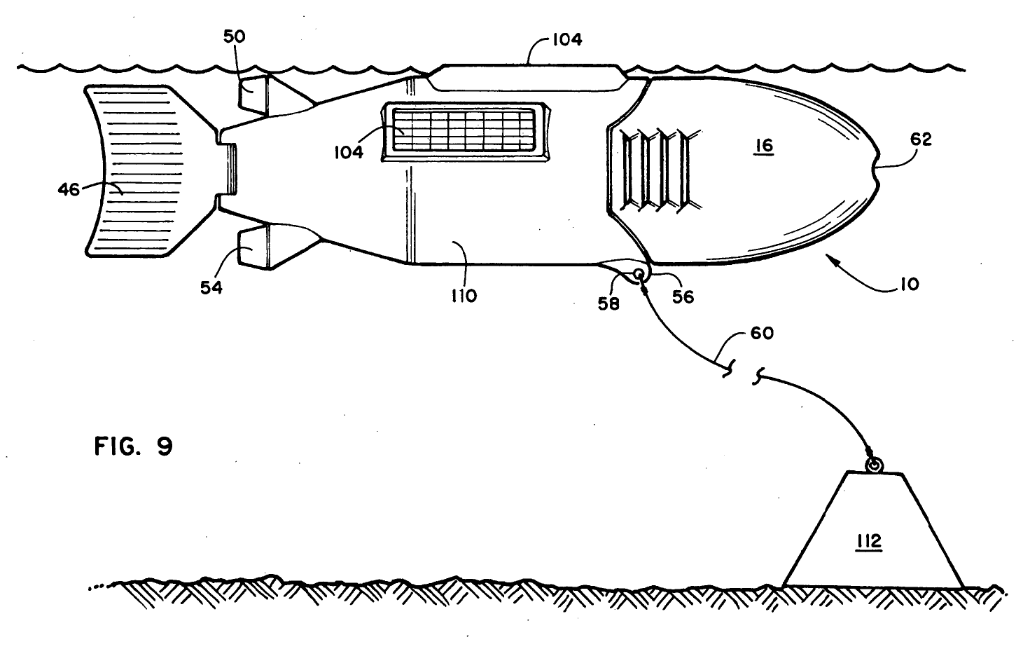

FIG. 9 depicts the self-propelled pool chemical dispenser 10 configured as a basic cylindrical shape 110 with photovoltaic energy cells 104 on the top and sides. This device will be tethered to a weight 112 on the bottom by the means of tether line 60 to go in a confined circular pattern.

The self-propelled pool chemical dispenser 10 shown in the drawings and described in detail herein disclose arrangements of elements of particular construction and configuration for illustrating preferred embodiments of structure and method of operation of the present invention. It is to be understood, however, that elements of different construction and configuration and other arrangements thereof, other than those illustrated and described may be employed for providing a self-propelled pool chemical dispenser 10 in accordance with the spirit of this invention, and such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

1. A chemical dispensing device for use in a medium comprising:
a) a housing having a first compartment and a second compartment, said first compartment and said second compartment being separated by a dividing wall, and said second compartment being in fluid communication with said medium;
b) propulsion means located in, on, and detachably attached to said first compartment, whereby said chemical dispensing device can be self-propelled through said medium;
c) chemical containment means located in said second compartment, whereby solid chemical compounds are stored for dispersion within a medium; and
d) chemical dispersement rate adjustment means, whereby the dispersement rate within a medium, of said solid chemical compounds stored for dispersion within said chemical containment means, is adjustable.

2. The chemical dispensing device for use in a medium, according to claim 1, wherein said first compartment is fully sealed from contamination by said medium, and further wherein said propulsion means located in said first compartment is sealed from contamination by said medium.

3. The chemical dispensing device for use in a medium, according to claim 1, wherein said first compartment further includes a flotation unit and a ballast unit to obtain a desired buoyancy for the device as a whole.

4. The chemical dispensing device for use in a medium, according to claim 1, wherein said propulsion means includes an electric motor, power transfer means and an external actuator for setting the device into motion.

5. The chemical dispensing device for use in a medium, according to claim 4, wherein said electric motor is powered by an on-board battery located in said first compartment and connected in electrical communication with said electric motor.

6. The chemical dispensing device for use in a medium, according to claim 4, wherein said external actuator for setting the device into motion is a fish fin-like actuator.

7. The chemical dispensing device for use in a medium, according to claim 4, wherein said external actuator for setting the device into motion is a propeller.

8. The chemical dispensing device for use in a medium, according to claim 4, wherein said electric motor is powered by on-board photovoltaic cells located on the upper portion of the device when said photovoltaic cells are exposed to light.

9. The chemical dispensing device for use in a medium, according to claim 1, wherein said chemical containment means located in said second compartment includes a detachably removable compartment cover, whereby, said cover is detached, removed, filled with solid chemical to be dispersed, and replaced prior to deployment of said device.

10. The chemical dispensing device for use in a medium, according to claim 1, wherein said chemical dispersement rate adjustment means includes a main orifice, a sliding door orifice and a sliding door, whereby the main orifice allows the medium to enter and react with the chemical stored therein and said sliding door allows the rate of expulsion of reacted medium within said second compartment to be adjusted by opening and closing the sliding door thereby increasing and decreasing the sliding door orifice area.

11. A method for making a chemical dispensing device for use in a medium, comprising the steps of:
a) providing a housing having a first compartment and a second compartment, said first compartment and said second compartment being separated by a dividing wall, and said second compartment being in fluid communication with said medium;
b) providing propulsion means located in, on, and detachably attached to said first compartment, whereby said chemical dispensing device can be self-propelled through said medium;
c) providing chemical containment means located in said second compartment, whereby solid chemical compounds are stored for dispersion within a medium; and
d) providing chemical dispersement rate adjustment means, whereby the dispersement rate within a medium, of said solid chemical compounds stored for dispersion within said chemical containment means, is adjustable.

12. The method for making a chemical dispensing device for use in a medium, according to claim 11, wherein said step of providing a housing further includes providing a first compartment that is fully sealed from contamination by said medium, and further wherein said propulsion means located in said first compartment is sealed from contamination by said medium.

13. The method for making a chemical dispensing device for use in a medium, according to claim 11, wherein said step of providing a housing includes providing a housing having a first compartment which further includes a flotation unit and a ballast unit to obtain a desired buoyancy for the device as a whole.

14. The method for making a chemical dispensing device for use in a medium, according to claim 11, wherein said step of providing propulsion means includes providing an electric motor, a power transfer means and an external actuator for setting the device into motion.

15. The method for making a chemical dispensing device for use in a medium, according to claim 14, wherein said step of providing an electric motor includes providing an electric motor which is powered by an on-board battery located in said first compartment and connected in electrical communication with said electric motor.

16. The method for making a chemical dispensing device for use in a medium, according to claim 14, wherein said step of providing an external actuator for setting the device into motion includes providing a fish fin-like actuator.

17. The method for making a chemical dispensing device for use in a medium, according to claim 14, wherein said step of providing an external actuator for setting the device into motion includes providing a propeller.

18. The method for making a chemical dispensing device for use in a medium, according to claim 14, wherein said step of providing an electric motor further includes providing an electric motor that is powered by on-board photovoltaic cells located on the upper portion of the device when said photovoltaic cells are exposed to light.

19. The method for making a chemical dispensing device for use in a medium, according to claim 11, wherein said step of providing chemical containment means located in said second compartment further includes providing a detachably removable compartment cover, whereby, said cover is detached, removed, filled with solid chemical to be dispersed, and replaced prior to deployment of said device.

20. The method for making a chemical dispensing device for use in a medium, according to claim 11, wherein said step of providing chemical dispersement rate adjustment means further includes providing a main orifice, a sliding door orifice and a sliding door, whereby the main orifice allows the medium to enter and react with the chemical stored therein and said sliding door allows the rate of expulsion of reacted medium within said second compartment to be adjusted by opening and closing the sliding door thereby increasing and decreasing the sliding door orifice area.
